(19) United States
(12) Patent Application Publication
(10) Pub. No.: US 2017/0090456 A1
(43) Pub. Date: Mar. 30, 2017

(54) AUTONOMOUS CLEANING ROBOT

(71) Applicant: Multimedia Image Solution Limited, Dublin (IE)

(72) Inventors: Kaixuan Mao, Dublin, CA (US); Hui Deng, San Ramon, CA (US); Caroline Tien-Spalding, Fremont, CA (US)

(21) Appl. No.: 14/866,831

(22) Filed: Sep. 25, 2015

(51) Int. Cl. G05B 19/404

(52) U.S. Cl. CPC G05B 19/404; G05B 2219/45098; Y10S 901/01; Y10S 901/46

(57) ABSTRACT

An autonomous cleaning robot performs a cleaning function and determines if an obstacle is in its path while performing the cleaning function. When an obstacle is in its path, the autonomous cleaning robot determines if a height of the obstacle is under a clearance height of the autonomous cleaning robot. When the height of the obstacle is under the clearance height of the autonomous cleaning robot, the autonomous cleaning robot determines if the obstacle is to be avoided. When the obstacle is to be avoided, the autonomous cleaning robot changes its path to avoid traversing over the obstacle.

### BACKGROUND

An autonomous cleaning robot may utilize a combination of sensors to navigate its environment, such as cameras to map a room, gyroscopes to track its movements, and obstacle sensors to detect ground-level objects. The cleaning robot has a ground clearance that allows it to traverse over obstacles under a certain height, such as extension cords, interfaces between rugs and hard flooring, and thresholds between rooms, which are disregarded or not detected by its obstacle sensors.

### BRIEF DESCRIPTION OF THE DRAWINGS

In the drawings:

FIG. 1 is a block diagram of an environment with an autonomous cleaning robot in examples of the present disclosure;

FIG. 2 is a block diagram of the autonomous cleaning robot of FIG. 1 in examples of the present disclosure;

FIG. 3 is a flowchart of a method performed by the autonomous cleaning robot of FIGS. 1 and 2 to avoid obstacles in examples of the present disclosure;

FIG. 4 is a flowchart of a method performed by the autonomous cleaning robot of FIGS. 1 and 2 to register objects in a room in examples of the present disclosure;

FIG. 5 is a flowchart of a method performed by the autonomous cleaning robot of FIGS. 1 and 2 to detect pests in examples of the present disclosure; and

FIG. 6 is a flowchart of a method performed by the autonomous cleaning robot of FIGS. 1 and 2 to detect lost objects in examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on. The term “or” is used to refer to a nonexclusive such that “A or B” includes “A but not B,” “B but not A,” and “A and B” unless otherwise indicated.

Prior art autonomous cleaning robots use laser sensors, ultrasonic sensors, or contact bumpers to detect obstacles that are taller than their ground clearance. For obstacles lower than the ground clearance, a prior art autonomous cleaning robot would traverse over the obstacles. For obstacles that are soft, a prior art autonomous cleaning robot with contact bumpers would fail to detect them and then either push or traverse over the obstacles.

The design of the prior art autonomous cleaning robots has led to a particular problem with homes that have pets. When a pet defecates, the animal feces may be low to the ground and soft. A prior art autonomous cleaning robot would fail to detect the animal feces, traverse over them, and smear the animal feces all over a home. Similar situation occurs with spilled liquids, dropped foods, and wet paint. Thus what is needed is a way to discern pet wastes from other obstacles that an autonomous cleaning robot may traverse.

The autonomous cleaning robot offers a versatile platform that can perform other functions in addition to cleaning as it moves throughout a home. Unfortunately up to now manufacturers have not taken advantage of this versatility. Thus what are needed are additional functions that take advantage of the autonomous cleaning robot.

Functionalities added to an autonomous cleaning robot may require a more powerful processor and a larger memory. Unfortunately faster processor and larger memory increase the cost of the autonomous cleaning robot. Thus what is needed is a way to add additional functionalities without increasing cost.

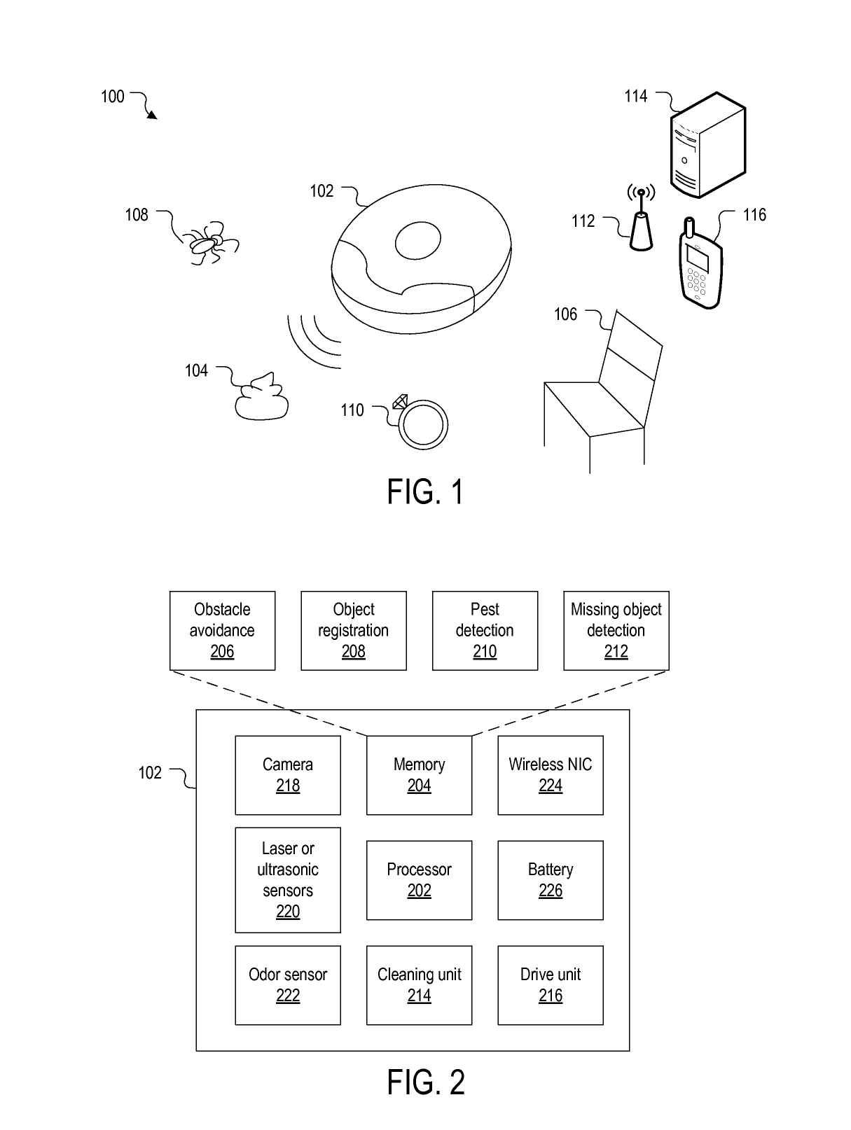

FIG. 1 is a block diagram of an environment 100 with an autonomous cleaning robot 102 in examples of the present disclosure. Autonomous cleaning robot 102 may be a cleaning vacuum robot, a floor scrubbing robot, a floor mopping robot, a floor buffing robot, a floor chemical treatment robot, a or a combination thereof (i.e., an autonomous cleaning robot 102 with multiple cleaning modes). To avoid traversing over certain types of obstacle, such as pet feces, spilled liquids, dropped foods, or wet paint, autonomous cleaning robot 102 uses image or video analysis to determine if it should navigate around an obstacle 104 that is lower than its ground clearance and in its cleaning path. Autonomous cleaning robot 102 is also provided with additional features in addition to cleaning Autonomous cleaning robot 102 may be configured to register objects 106 in a room, detect pests 108, or find missing objects 110.

Autonomous cleaning robot 102 may be equipped with the necessary processing power to locally perform the many algorithms that govern its behavior, such as mapping out a cleaning path, avoiding obstacles, registering objects, detecting pests, and finding missing objects. Alternatively autonomous cleaning robot 102 may transmit data collected by its sensors through a network 112 to a computer, a tablet computer, or a smart phone 114, which may remotely process the data and return the result to allow the autonomous cleaning robot to determine its behavior. Network 112 may include a local wireless network or both the local wireless network and the Internet. Device 114 may be a local computer at the premises or one or more remote server computers at the location of the manufacturer or in the cloud. This arrangement takes advantage of the fact that many existing devices have power processor and memory that can run the necessary algorithms to perform these functions for autonomous cleaning robot 102.

An application may be installed on a user device 116, such as a smart phone or a tablet computer, for the user to interact with autonomous cleaning robot 102. Autonomous cleaning robot 102 and user device 116 may communicate over wireless network 112.

FIG. 2 is a block diagram of autonomous cleaning robot 102 in examples of the present disclosure. Autonomous cleaning robot 102 includes at least one processor 202 and a memory 204 storing nonvolatile instructions of algorithms to be executed by the processor. The instructions may also be downloaded or updated from the Internet. The algorithms include obstacle avoidance 206, object registration 208, pest detection 210, and missing object detection 212. Autonomous cleaning robot 102 further includes a cleaning unit 214, a drive unit 216, a camera 218, laser or ultrasonic sensors 220, an odor sensor 222, a wireless network interface card (NIC) 224, and a power source 226, such as a rechargeable battery. Cleaning unit 214 may be a vacuum with a dust bin, a powered scrubber with a liquid or gel reservoir, a mop with a liquid or gel reservoir, or a combination thereof. Drive unit 216 may be motorized wheels or tracks. Camera 218 may have a thermal imaging mode or autonomous cleaning robot 102 may include additional thermal imaging camera. Laser or ultrasonic sensors 220 may detect ground-level obstacles and their height. Odor sensor 222 may sample the air and generate odor signatures. Wireless NIC 224 may communicate with wireless network 112 in FIG. 1. Battery 226 powers all the components, which are under the control of processor 202.

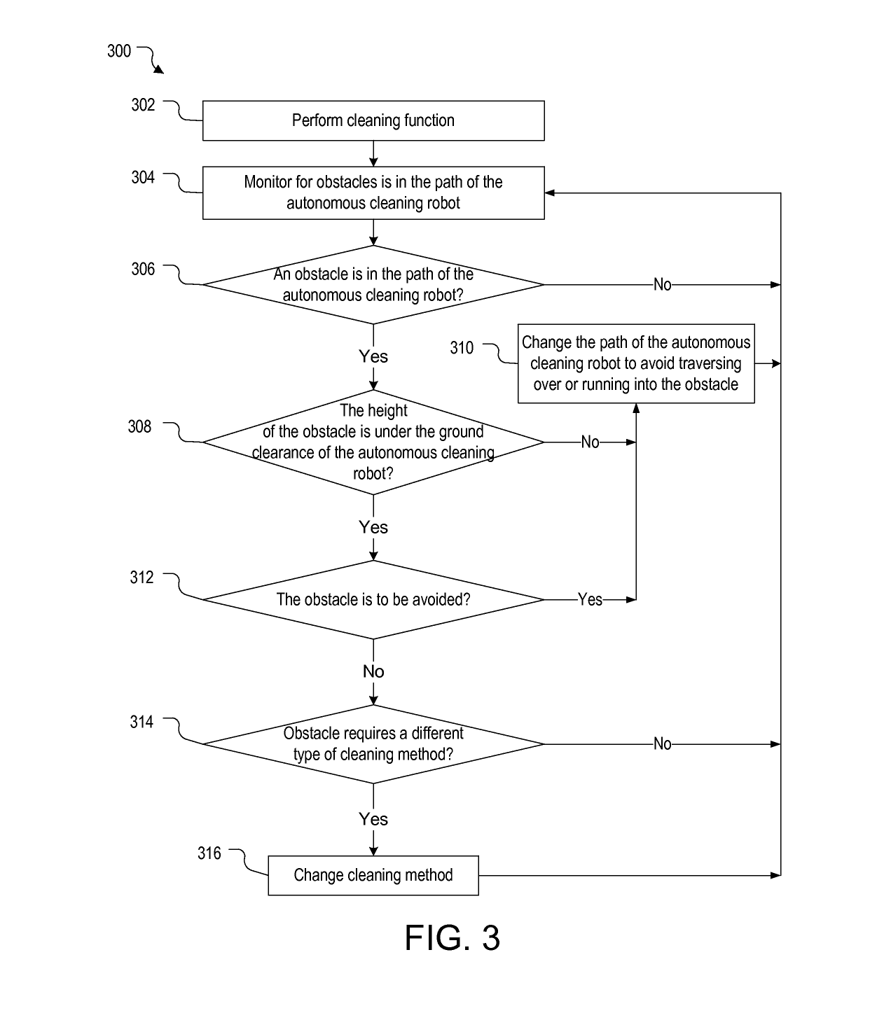

FIG. 3 is a flowchart of a method 300 for autonomous cleaning robot 102 (FIGS. 1 and 2) to avoid obstacles in examples of the present disclosure. Method 300 may be implemented by processor 202 (FIG. 2) executing the instructions for obstacle avoidance algorithm 206 (FIG. 2) stored in memory 204 (FIG. 2). Method 300 and other methods described herein may include one or more operations, functions, or actions illustrated by one or more blocks. Although the blocks of method 300 and other methods described herein are illustrated in sequential orders, these blocks may also be performed in parallel, or in a different order than those described herein. Also, the various blocks may be combined into fewer blocks, divided into additional blocks, or eliminated based upon the desired implementation. Method 300 may begin in block 302.

In block 302, processor 202 causes autonomous cleaning robot 102 to perform its cleaning function. For example processor 202 uses cleaning unit 214 (FIG. 2) to vacuum, scrub, or mop a room. Using video captured by camera 218 (FIG. 2), processor 202 maps a cleaning path and directs drive unit 216 (FIG. 2) to follow the path. Block 302 may be followed by block 304.

In block 304, processor 202 monitors for obstacles in its path. For example processor 202 uses laser or ultrasonic sensors 220 to detect obstacles in its path. Alternatively processor 202 may use camera 218 and video analysis to detect obstacles in its path. Block 304 may be followed by block 306.

In block 306, processor 202 determines if an obstacle is in its path. If so, block 306 may be followed by block 308. Otherwise block 306 may loop back to block 304 where processor 202 continues to monitor for obstacles in its path.

In block 308, processor 202 determines if the height of the obstacle is less than the ground clearance of autonomous cleaning robot 102. For example processor 202 uses laser or ultrasonic sensors 220 to detect the height of the obstacle. Alternatively processor 202 may use camera 218 and video analysis to detect the height of the obstacle. If the height of the obstacle is not less than the ground clearance of autonomous cleaning robot 102, block 308 may be followed by block 310. Otherwise block 308 may be followed by block 312.

In block 310, processor 202 changes the path of autonomous cleaning robot 102 to avoid traversing over or running into the obstacle. Block 310 may loop back to block 304 where processor 202 continues to monitor for obstacles in its path.

In block 312, processor 202 determines if the obstacle is to be avoided even though it could be traversed over. For example processor 202 uses camera 218 and video analysis to determine if the obstacle is a type to be avoided, such as pet feces, spilled liquids, dropped foods, or wet paint. Processor 202 receives an image from camera 218, determining a visual or thermal signature of the obstacle from the image, and searches through visual or thermal signatures of obstacles to be avoided (stored in memory 204) to find a matching visual or thermal signature to the obstacle. A visual or thermal signature may be a set of unique features extracted from an object detected in an image. In another example processor 202 may use odor sensor 222 (FIG. 2) and odor analysis to determine if the obstacle is a type to be avoided. Processor 202 receives an odor signature from odor sensor 222 and searches through odor signatures of obstacles to be avoided (stored in memory 204) to find a matching odor signature to the obstacle. In an additional example, processor 202 performs both image and odor analysis to determine if the obstacle is a type to be avoided.

If the obstacle is to be avoided, then block 312 may be followed by block 310. Otherwise block 312 may be followed by block 314.

In block 314, processor 202 determines if the cleaning method of autonomous cleaning robot 102 is to be changed based on the obstacle. For example, processor 202 uses camera 218 and video analysis to determine if the obstacle is a type that can be cleaned using a different mode, such as a liquid that autonomous cleaning robot 102 can clean in its scrubbing or mopping mode instead of its vacuum mode. If the cleaning method of autonomous cleaning robot 102 is to be changed, block 314 may be followed by block 316. Otherwise block 314 may be followed by block 310 to avoid the obstacle.

In block 316, processor 202 changes the cleaning method of autonomous cleaning robot 102 to one that is appropriate for the obstacle. Block 316 may loop back to block 304 where processor 202 continues to monitor for obstacles in its path.

As described above processor 202 performs obstacle avoidance algorithm 206 locally. Alternatively processor 202 may transmit data collected by its sensors through network 112 to device 114, which may remotely process the data and return the result to autonomous cleaning robot 102.

For example processor 202 receives an image or an odor signature from camera 218 or odor sensor 222 and uses wireless NIC 224 to transmit the image or the odor signature to device 114. In response device 114 analyzes the image or the odor signature in real-time to determine if an obstacle is to be avoided and wirelessly transmits the result to autonomous cleaning robot 102.

In another example processor 202 receives a video from camera 218 and uses wireless NIC 224 to transmit the video to device 114. In response device 114 analyzes the video in real-time to determine if the obstacle is in the path of autonomous cleaning robot 102 and if the obstacle is under the clearance height of the autonomous cleaning robot.

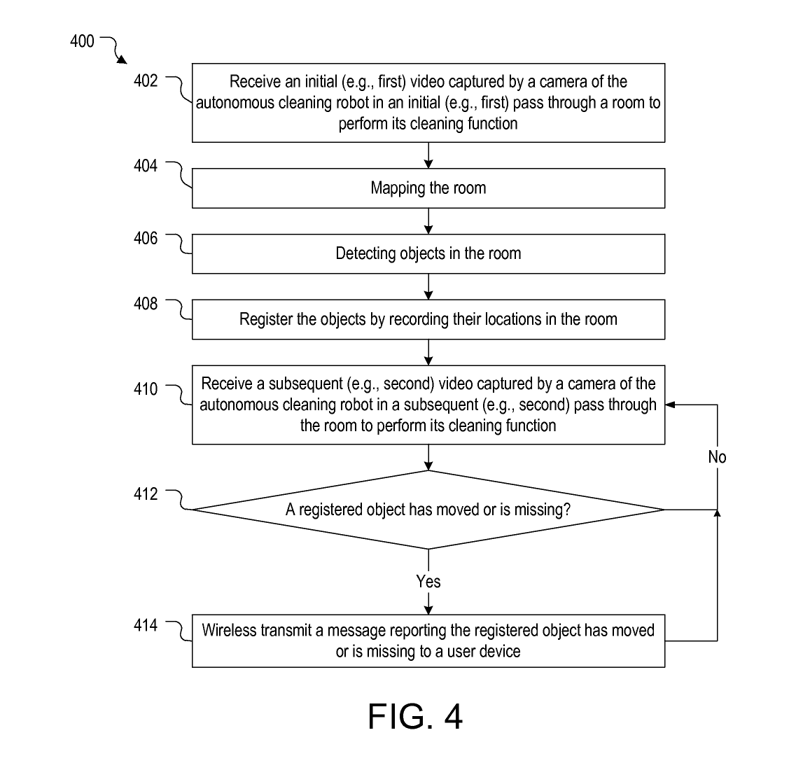

FIG. 4 is a flowchart of a method 400 for autonomous cleaning robot 102 (FIGS. 1 and 2) to register objects in examples of the present disclosure. Method 400 may be implemented by processor 202 (FIG. 2) executing the instructions for object registration algorithm 208 (FIG. 2) stored in memory 204 (FIG. 2). Method 400 may begin in block 402.

In block 402, processor 202 receives an initial (e.g., first) video captured by camera 218 as autonomous cleaning robot 102 makes an initial (e.g., first) pass through a room to perform its cleaning function. Block 402 may be followed by block 404.

In block 404, processor 202 maps the room based on the first video. Block 404 may be followed by block 406.

In block 406, processor 202 detects objects in the room based on the first video. For example processor 202 uses edge detection to extract the objects from the first video. Block 406 may be followed by block 408.

In block 408, processor 202 registers the objects by recording their locations in the room. Processor 202 may present the registered objects to a user through an application on device 114 (FIG. 1) or user device 116 (FIG. 1), and the user may name and delete registered objects as appropriate. Block 408 may be followed by block 410.

In block 410, processor 202 receives a subsequent (e.g., second) video captured by camera 218 as autonomous cleaning robot 102 makes a subsequent (e.g., second) pass through the room to perform its cleaning function. Block 410 may be followed by block 412.

In block 412, processor 202 determines if any registered object has moved or is missing based on the second video. For example processor 202 compares the previously recorded locations of the registered objects with their current locations to determine any registered object has moved or is missing. If processor 202 determines a registered object has moved or is missing, block 412 may be followed by block 414. Otherwise block 414 may loop back to block 410 for any subsequent pass through the room.

In block 414, processor 202 transmits a message reporting a registered object has moved or is missing to device 114 (FIG. 1) or user device 116 (FIG. 1). For example processor 202 uses wireless NIC 224 to transmit the message to an application on user device 116. Block 414 may loop back to block 410 for any subsequent pass through the room.

As described above processor 202 performs object registration algorithm 208 locally. Alternatively processor 202 receives videos from camera 218 and uses wireless NIC 224 to transmit the videos to device 114. In response device 114 analyzes the first video in real-time to map a room, detect objects in the room, and register the objects by recording their locations in the room, and the computer analyzes the second video in real-time to determine if any registered object has moved or is missing and transmit a message to user device 116 when a registered object has moved or is missing.

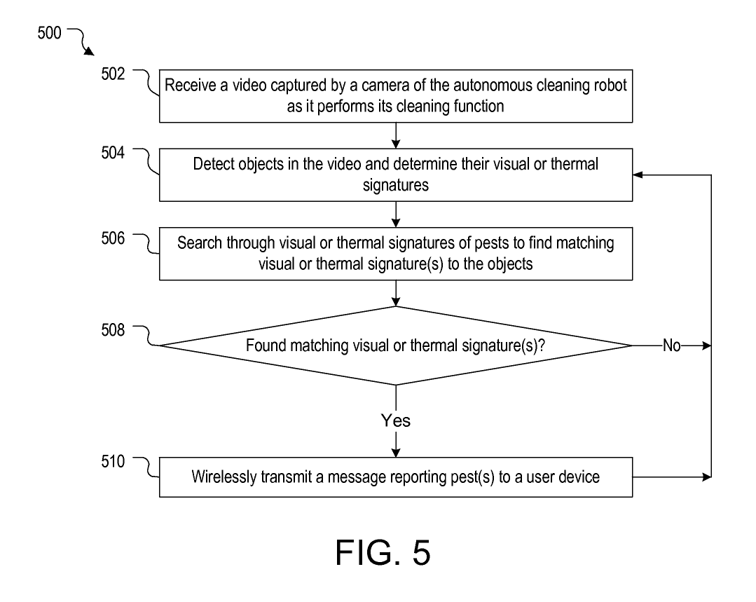

FIG. 5 is a flowchart of a method 500 for autonomous cleaning robot 102 (FIGS. 1 and 2) to detect pests in examples of the present disclosure. Method 500 may be implemented by processor 202 (FIG. 2) executing the instructions for pest detection algorithm 210 (FIG. 2) stored in memory 204 (FIG. 2). Method 500 may begin in block 502.

In block 502, processor 202 receives a video captured by camera 218 as autonomous cleaning robot 102 performs its cleaning function. Block 502 may be followed by block 504.

In block 504, processor 202 detects objects in the video and determines their visual or thermal signatures. Block 504 may be followed by block 506.

In block 506, processor 202 searches through visual or thermal signatures of pests (stored in memory 204) to find matching visual or thermal signatures to the objects in the video. Block 506 may be followed by block 508.

In block 508, processor 202 determines if one or more matching visual or thermal signatures have been found. If so, block 508 may be followed by block 510. Otherwise block 508 may be followed by block 504 to detect more objects in the video.

In block 510, processor 202 transmits a message reporting one or more locations of one or more pests to device 114 (FIG. 1) or user device 116 (FIG. 1). For example processor 202 uses wireless NIC 224 to transmit the message to an application on user device 116.

As described above processor 202 performs pest detection algorithm 210 locally. Alternatively processor 202 receives a video from camera 218 and uses wireless NIC 224 to transmit the video to device 114. In response device 114 analyzes the video in real-time to determine visual or thermal signatures of objects in the video, search through visual or thermal signatures of pests to find matching visual or thermal signatures to the objects, and transmitting a message reporting pests to a user device when matching visual or thermal signatures are found.

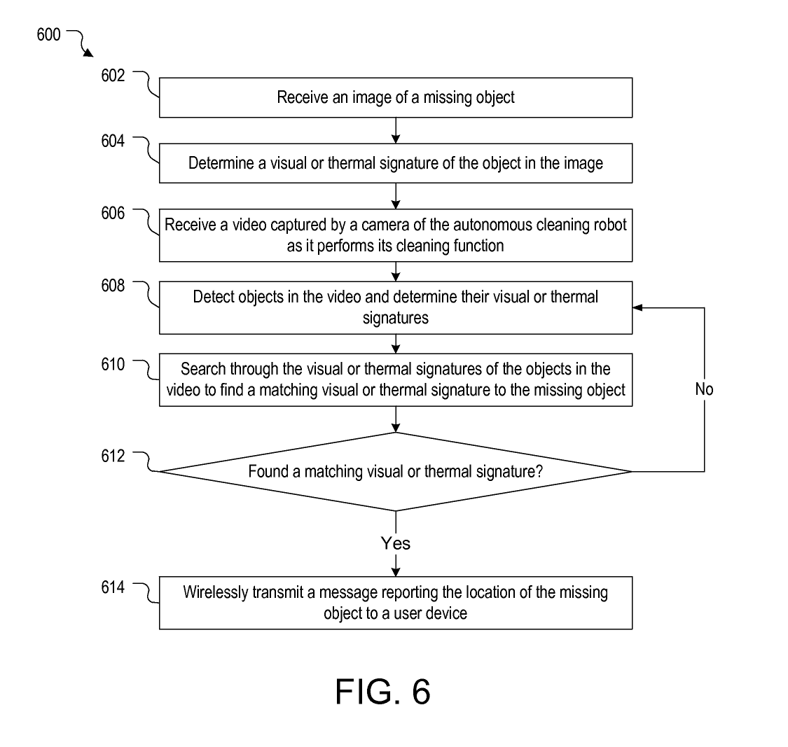

FIG. 6 is a flowchart of a method 600 for autonomous cleaning robot 102 (FIG. 2) to find a missing object in examples of the present disclosure. Method 600 may be implemented by processor 202 (FIG. 2) executing the instructions for missing object detection algorithm 212 (FIG. 2) stored in memory 204 (FIG. 2). Method 600 may begin in block 602.

In block 602, processor 202 receives an image of a missing object a user wishes to locate. Through an application on device 114 (FIG. 1) or user device 116 (FIG. 1), the user may capture the image and transmit it to autonomous cleaning robot 102. Block 602 may be followed by block 604.

In block 604, processor 202 determines a visual or thermal signature of the missing object in the image. Block 604 may be followed by block 606.

In block 606, processor 202 receives a video captured by camera 218 as autonomous cleaning robot 102 performs its cleaning function. Block 606 may be followed by block 608.

In block 608, processor 202 detects objects in the video and determines their visual or thermal signatures. Block 608 may be followed by block 610.

In block 610, processor 202 searches through visual or thermal signatures of objects in the video to find a matching visual or thermal signature to the missing objects. Block 610 may be followed by block 612.

In block 610, processor 202 determines if a matching visual or thermal signature has been found. If so, block 610 may be followed by block 612. Otherwise block 610 may be followed by block 608 to detect more objects in the video.

In block 612, processor 202 transmits a message reporting the locations of the missing object to device 114 or user device 116. For example processor 202 uses wireless NIC 224 to transmit the message to an application on user device 116.

As described above processor 202 performs missing object detection algorithm 212 locally. Alternatively processor 202 receives a video from camera 218 and uses wireless NIC 224 to transmit the video to device 114. In response device 114 analyzes the video in real-time to generate visual or thermal signatures of objects in the video, search through the visual or thermal signatures of the objects in the video find a matching visual or thermal signature to the missing object, and transmitting a message reporting the missing object to user device 116 when the matching visual or thermal signature is found.

Although methods 300, 400, 500, and 600 are described separately, processor 202 may perform two or more of the methods in parallel.

Various other adaptations and combinations of features of the embodiments disclosed are within the scope of the present disclosure. Numerous embodiments are encompassed by the following claims.

What is claimed is:

1. A method executed by an autonomous cleaning robot, comprising:
performing a cleaning function along a path;
determining if an obstacle is in the path of the autonomous cleaning robot;
when the obstacle is in the path of the autonomous cleaning robot, determining if a height of the obstacle is under a clearance height of the autonomous cleaning robot;
when the height of the obstacle is under the clearance height of the autonomous cleaning robot, determining if the obstacle is to be avoided; and
when the obstacle is to be avoided, changing the path of the autonomous cleaning robot to avoid traversing over the obstacle.

2. The method of claim 1, wherein determining if the obstacle is to be avoided comprises:
receiving an image from a camera of the autonomous cleaning robot;
determining a visual or thermal signature of the obstacle from the image; and
searching through visual or thermal signatures of obstacles to be avoided to find a matching visual or thermal signature to the visual or thermal signature of the obstacle from the image.

3. The method of claim 2, wherein determining if the obstacle is in a path of the autonomous cleaning robot and determining if the obstacle is under the clearance height of the autonomous cleaning robot comprise using video analysis, a laser sensor, or an ultrasonic sensor.

4. The method of claim 1, wherein determining if the obstacle is to be avoided comprises:
receiving an odor signature from an odor sensor of the autonomous cleaning robot; and
searching through odor signatures of obstacles to be avoided to find a matching odor signature to the odor signature.

5. The method of claim 4, wherein determining if the obstacle is in a path of the autonomous cleaning robot and determining if the obstacle is under the clearance height of the autonomous cleaning robot comprise using video analysis, a laser sensor, or an ultrasonic sensor.

6. The method of claim 1, wherein determining if the obstacle is to be avoided comprises:
receiving an image or an odor signature from the camera or the odor sensor of the autonomous cleaning robot; and
transmitting the image or the odor signature to a local or a remote computer, wherein in real-time the local or remote computer determines if the obstacle is to be avoided and transmits a result to the autonomous cleaning robot.

7. The method of claim 6, wherein determining if the obstacle is in the path of the autonomous cleaning robot and determining if the height of the obstacle is under the clearance height of the autonomous cleaning robot comprise:
receiving a video from the camera of the autonomous cleaning robot; and
transmitting the video to the local or remote computer, wherein in real-time the local or remote computer analyzes the video to determine if the obstacle is in the path of the autonomous cleaning robot and if the obstacle is under the clearance height of the autonomous cleaning robot.

8. The method of claim 1, further comprising:
based on a first video captured by a camera of the autonomous cleaning robot in a first pass through a room:
mapping the room;
detecting objects in the room; and
recording the locations of the objects in the room;
based on a second video captured by the camera of the autonomous cleaning robot in a second pass through the room, detecting if any object has been moved or is missing; and
when an object has been moved or is missing, transmitting a message reporting the object has moved or is missing to a computer or a user device.

9. The method of claim 1, further comprising:
transmitting a first video captured by a camera of the autonomous cleaning robot in a first pass through a room to a local or remote computer, wherein in real-time the local or remote computer maps the room, detects objects in the room, and records the locations of the objects in the room based on the first video; and
transmitting a second video captured by the camera of the autonomous cleaning robot in a second pass through the room to the local or remote computer, wherein in real-time the local or remote computer detects if any object has been moved or is missing based on the second video and, when an object has moved or is missing, transmits a message reporting the object has moved or is missing to a user device.

10. The method of claim 1, further comprising:
determining a visual or thermal signature of an object in a video captured by a camera of the autonomous cleaning robot;
searching through visual or thermal signatures of pests to find a matching visual or thermal signature to the visual or thermal signature of the object;
when the matching visual or thermal signature is found, transmitting a message reporting a pest to a computer or a user device.

11. The method of claim 1, further comprising:
receiving a video from a camera of the autonomous cleaning robot; and
transmitting the video to a local or remote computer, wherein in real-time the local or remote computer determines a visual or thermal signature of an object in the video, searches through visual or thermal signatures of pests to find a matching visual or thermal signature to the visual or thermal signature of the object, and, when the matching visual or thermal signature is found, transmitting a message reporting a pest to a user device.

12. The method of claim 1, further comprising:
receiving an image of a missing object;
determining a visual or thermal signature of the missing object in the image;
receiving a video captured by a camera of the autonomous cleaning robot;
generating visual or thermal signatures of objects in the video;
searching through the visual or thermal signatures of the objects in the video to find a matching visual or thermal signature to the visual or thermal signature of the missing object; and
when the matching visual or thermal signature is found, transmitting a message reporting the missing object to a computer or a user device.

13. The method of claim 1, further comprising transmitting a video captured by a camera of the autonomous cleaning robot to a local or remote computer, wherein the local or remote computer generates visual or thermal signatures of objects in the video, searches through the visual or thermal signatures of the objects in the video find a matching visual or thermal signature to the visual or thermal signature of the missing object, and, when the matching visual or thermal signature is found, transmitting a message reporting the missing object to a user device.

14. The method of claim 1, further comprising:
when the obstacle is not to be avoided, determining if the obstacle is to be cleaned with a different cleaning method than a current cleaning method; and
when the obstacle is to be cleaned with the different cleaning method, changing from the current cleaning method to the different cleaning method.

15. An autonomous cleaning robot, comprising:
a cleaning unit;
a drive unit;
a camera;
an obstacle sensor;
a memory comprising nonvolatile instructions; and
a processor executing the nonvolatile instructions to:
use the obstacle sensors determine if an obstacle is in a path of the autonomous cleaning robot;
when the obstacle is in the path of the autonomous cleaning robot, use the obstacle sensor to determine if a height of the obstacle is under a clearance height of the autonomous cleaning robot;
when the height of the obstacle is under the clearance height of the autonomous cleaning robot, use the camera to capture an image of the obstacle and analyze the image to determine if the obstacle is to be avoided; and
when the obstacle is to be avoided, change the path of the autonomous cleaning robot to avoid traversing over the obstacle.

16. The autonomous cleaning robot of claim 15, wherein the obstacle sensors comprise laser or ultrasonic sensors.

17. The autonomous cleaning robot of claim 15, further comprising an odor sensor, wherein the processor further executes the instructions to use the odor sensor to capture an odor signature and analyze the odor signature to determine if the obstacle is to be avoided.

18. The autonomous cleaning robot of claim 15, wherein the processor further executes the nonvolatile instructions to:
based on a first video captured by the camera in a first pass through a room:
mapping the room;
detecting objects in the room; and
recording the locations of the objects in the room;
based on a second video captured by the camera in a second pass through the room, detecting if any object has been moved or is missing; and
when an object has been moved or is missing, transmitting a message reporting the object has moved or is missing to a computer or a user device.

19. The autonomous cleaning robot of claim 18, wherein the processor further executes the nonvolatile instructions to:
determining a visual or thermal signature of a target object;
receiving a video captured by a camera;
generating visual or thermal signatures of objects in the video;
searching through the visual or thermal signatures of the objects in the video to find a matching visual or thermal signature to the visual or thermal signature of the target object; and
when the matching visual or thermal signature is found, transmitting a message reporting the target object to a computer or a user device.

20. The autonomous cleaning robot of claim 19, wherein the processor further executes the nonvolatile instructions to:
when the obstacle is not to be avoided, determining if the obstacle is to be cleaned with a different cleaning method than a current cleaning method; and
when the obstacle is to be cleaned with the different cleaning method, changing from the current cleaning method to the different cleaning method.
